(19) United States
(12) Patent Application Publication
(10) Pub. No.: US 2024/0348798 A1
(43) Pub. Date: Oct. 17, 2024

(54) PALETTE INTRA PREDICTION FOR VIDEO ENCODING

(71) Applicants: James Holland, Folsom, CA (US); Jian Hu, El Dorado Hills, CA (US); Dmitry Ryzhov, Mountain View, CA (US); Satya Yedidi, Roseville, CA (US)

(72) Inventors: James Holland, Folsom, CA (US); Jian Hu, El Dorado Hills, CA (US); Dmitry Ryzhov, Mountain View, CA (US); Satya Yedidi, Roseville, CA (US)

(21) Appl. No.: 18/755,165

(22) Filed: Jun. 26, 2024

(51) Int. Cl. H04N 19/159; H04N 19/124; H04N 19/176; H04N 19/186

(52) U.S. Cl. CPC H04N 19/159; H04N 19/124; H04N 19/176; H04N 19/186

(57) ABSTRACT

Systems, apparatus, articles of manufacture, and methods to implement palette intra prediction for video encoding are disclosed. Example apparatus disclosed herein are to map luminance components of pixels of a coding block of input video to respective palette index values and respective residual values. Disclosed example apparatus are also to encode the respective palette index values and the respective residual values to determine palette encoded luminance data for the coding block. Disclosed example apparatus are further to encode chrominance components of the pixels based on a coding type different from palette encoding to determine encoded chrominance data for the coding block.

### BACKGROUND

Video codecs exploit spatial and temporal redundancies in video to produce an encoded video bitstream that is compressed relative to the input video. Multiple different video coding types are employed by modern video codecs, such as inter coding, intra coding, intra block copy coding, palette coding, etc. Some video coding types, such as inter coding and intra coding, are tailored for encoding natural video content, such as video content captured with a camera or other sensor. Other video coding types, such as intra block copy coding and palette coding, are tailored to computer generated video content, also referred to as screen content.

### BRIEF DESCRIPTION OF THE DRAWINGS

FIG. 1 is a block diagram of an example video encoder that implements palette intra prediction encoding in accordance with teachings of this disclosure.

FIG. 2 is a block diagram of example rate distortion optimization circuitry included in the video encoder of FIG. 1.

FIG. 3 is a block diagram of example palette coding cost estimation circuitry included in the rate distortion optimization circuitry of FIG. 2.

FIGS. 4-7 are flowcharts representative of example machine readable instructions and/or example operations that may be executed, instantiated, and/or performed by example programmable circuitry to implement the video encoder 100 of FIGS. 1-3.

FIG. 8 is a block diagram of an example processing platform including programmable circuitry structured to execute, instantiate, and/or perform the example machine readable instructions and/or perform the example operations of FIGS. 4-7 to implement the video encoder 100 of FIGS. 1-3.

FIG. 9 is a block diagram of an example implementation of the programmable circuitry of FIG. 8.

FIG. 10 is a block diagram of another example implementation of the programmable circuitry of FIG. 8.

FIG. 11 is a block diagram of an example software/firmware/instructions distribution platform (e.g., one or more servers) to distribute software, instructions, and/or firmware (e.g., corresponding to the example machine readable instructions of FIGS. 4-7) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Video codecs exploit spatial and temporal redundancies to achieve compression of predictable patterns in video. However, some patterns of pixels are relatively rare or not found in natural video content (e.g., video captured with a camera) but are more common for synthetic, computer generated content (e.g., such as content associated with screen sharing, remote desktop applications, cloud gaming, screen recording, etc.), also referred to as synthetic content or screen content. Earlier video codecs ignored such patterns as they were standardized before modern use cases in which synthetic video has become more prevalent. By way of example, the High Efficiency Video Coding (HEVC) video standard added extensions for screen content coding tools multiple years after the original HEVC standard was finalized. Conversely, more recent video codec standards, such as the AV1 standard by the Alliance for Open Media, included screen content coding tools, such as intra block copy (IBC), identity transform, palette coding, from the beginning.

Palette coding in AV1 involves determining a set of colors, referred to as a color palette, to be used to encode a coding block of an image frame, such as a coding block of 16×16 pixels or some other block size. The pixels of the coding block are encoded into respective palette indexes and residuals. The combination of encoding the pixels into indexes of a color palette and then run length encoding the indexes can achieve substantial compression gains for screen content coding.

Example palette intra prediction coding techniques disclosed herein simplify and modify prior palette-based encoding techniques to achieve AV1-compliant palette coding but with reduced computational and/or memory utilization relative to prior techniques. For example, some palette intra prediction coding examples disclosed herein limit palette encoding to one video component, such as the luminance component of the video, and utilize another video coding type, such as intra coding, to encode the chrominance components of the video. In this way, the different possible combinations of coding types to be evaluated by the video encoder are reduced, thereby simplifying video encoder operation and yielding computational and memory resource savings.

Additionally or alternatively, some palette intra prediction coding examples disclosed herein modify the way the cost of palette coding is estimated relative to other cost estimation techniques. Palette coding cost is used by a video encoder as part of its rate distortion optimization evaluation of palette coding relative to other potential candidate coding types to be used to encode a given coding block of a video frame. In some palette intra prediction coding examples disclosed herein, palette coding cost is estimated for a given coding block based on a regression model (e.g., such as a linear model) that is evaluated using the palette index values used to encode the given coding block. This regression model technique can be simpler than other cost estimation techniques, resulting in computational and memory resource savings.

Additionally or alternatively, some palette intra prediction coding examples disclosed herein implement a palette override procedure that replaces another coding type candidate for a given coding block with a palette coding candidate prior to rate distortion optimization evaluation in the video encoder. In some examples, the palette override procedure employs a scale factor to bias the override either for or against the palette coding candidate based on whether the video content has characteristics of screen content or natural content. Performing such an override replacement before rate distortion optimization evaluation reduces the number of coding type candidates to be evaluated by the video encoder for a given coding block, thereby resulting in computational and memory resource savings.

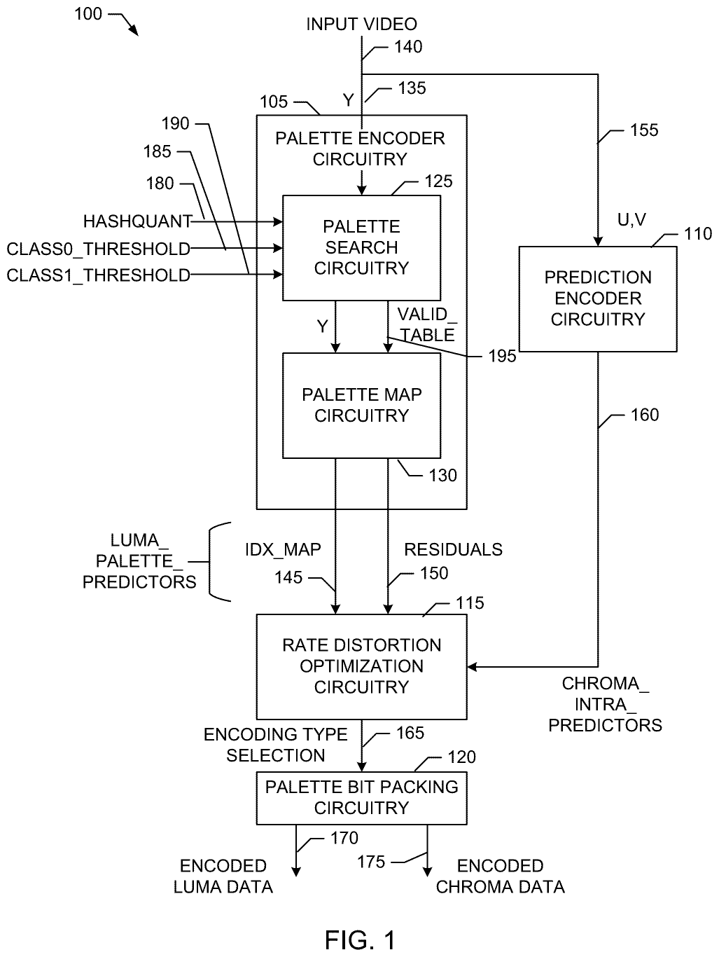

Turning to the figures, FIG. 1 is a block diagram of an example video encoder 100 that implements palette intra prediction encoding in accordance with teachings of this disclosure. The video encoder 100 of FIG. 1 may be instantiated (e.g., creating an instance of, bring into being for any length of time, materialize, implement, etc.) by programmable circuitry such as a Central Processor Unit (CPU) executing first instructions. Additionally or alternatively, the video encoder 100 of FIG. 1 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 1 may, thus, be instantiated at the same or different times. Some or all of the circuitry of FIG. 1 may be instantiated, for example, in one or more threads executing concurrently on hardware and/or in series on hardware. Moreover, in some examples, some or all of the circuitry of FIG. 1 may be implemented by microprocessor circuitry executing instructions and/or FPGA circuitry performing operations to implement one or more virtual machines and/or containers.

The example video encoder 100 of FIG. 1 includes example palette encoder circuitry 105, example prediction encoder circuitry 110, example rate distortion optimization circuitry 115, and example palette bit encoder circuitry 120. The prediction encoder circuitry 110 of the illustrated example includes example palette search circuitry 125 and example palette map circuitry 130. Other circuitry that may be included in the video encoder 100 to provide a complete video codec solution is omitted for clarity.

In the illustrated example of FIG. 1, the palette encoder circuitry 105 includes an example luminance input 135 to accept the luminance component (e.g., the Y component) of an example input video 140. In some examples, the luminance input 135 accepts the luminance components of pixels of a coding block to be encoded. The palette encoder circuitry 105 operates to palette encode the luminance components of the coding block pixels applied to the luminance input 135 to produce respective palette indexes and respective residuals representative of the luminance components of the coding block pixels. The respective palette indexes identify selected color values (e.g., closest color values) of a color palette to be used to represent the corresponding luminance values of the pixels of the coding block. The residuals represent the respective differences between the luminance values of the respective pixels and the colors (e.g., intensities, brightnesses, gray levels, etc.) corresponding to their selected palette indexes. For example, because the video encoder 100 limits palette encoding to the luminance components of the coding block pixels, the colors in the color palette may be different gray levels representative of different pixel intensities, brightnesses, etc. The palette encoder circuitry 105 includes an example index map (IDX_MAP) output 145 and an example residual output 150 to output the palette indexes and residuals, respectively, of the coding block pixels. In some examples, the palette indexes and residuals for a coding block are referred to collectively as the luminance (or luma) palette predictors for the coding block. Further details concerning the palette encoder circuitry 105 are provided below.

The prediction encoder circuitry 110 of the illustrated example implements one or more coding types other than palette coding. In the illustrated example, the prediction encoder circuitry 110 operates to encode the chrominance components of pixels of a coding block for which the luminance components of the pixels have been palette encoded by the palette encoder circuitry 105. As such, the prediction encoder circuitry 110 includes an example chrominance input 155 to accept the chrominance components (e.g., the U/V components) of the input video 140. In some examples, the chrominance input 155 accepts the chrominance components of pixels of a coding block to be palette encoded.

As used herein, a coding block is considered to be palette encoded if the luminance components of the coding block pixels are palette encoded even though the chrominance components of the coding block are encoded based on a coding type different from palette encoding. In the illustrated example, the prediction encoder circuitry 110 encodes the chrominance components of a palette encoded coding block based on intra coding, whereas the luminance components of the palette encoded coding block are palette encoded by the palette encoder circuitry 105. As such, the prediction encoder circuitry 110 includes an example chrominance (chroma) intra predictors output 160 to output the intra prediction data determined by the prediction encoder circuitry 110 to encode the chrominance components of a palette encoded coding block. However, in some examples, the prediction encoder circuitry 110 additionally or alternatively encodes the chrominance components of a palette encoded coding block based on one or more other coding types, such as inter coding, IBC, etc.

The combination of palette indexes and residuals output by the palette encoder circuitry 105 for the luminance components of a given coding block (e.g., the luma palette predictors) and the intra prediction data output by the prediction encoder circuitry 110 for the chrominance components of the given coding block (e.g., the chroma intra predictors) form a palette coding candidate for the given coding block being encoded. In the illustrated example of FIG. 1, the rate distortion optimization circuitry 115 implements rate distortion optimization (RDO) to evaluate the palette coding candidate for a given coding block being encoded against other coding candidates determined for the given coding block based on other coding types (e.g., intra coding, inter code, IBC, etc.) implemented by the video encoder 100. As such, the RDO circuitry 115 includes an example encoding type selection output 165 to identify the selected (e.g., winning) coding candidate for a given coding block.

With respect to the palette coding candidate provided by the palette encoder circuitry 105 and the prediction encoder circuitry 110, the RDO circuitry 115 also implements one or more simplification and modification enhancements to, for example, yield computational and memory resource savings for the video encoder 100. For example, the RDO circuitry 115 implements an example palette coding cost estimation procedure to estimate the coding cost of the palette coding candidate (e.g., the number of bits to be used to encode the palette coding candidate) based on a regression model (e.g., such as a linear model) that is evaluated using the palette index values determined by the palette encoder circuitry 105 for the given coding block. In some examples, the RDO circuitry 115 additionally or alternatively implements an example palette override procedure that replaces another coding type candidate for a given coding block with the palette coding candidate prior to the RDO evaluation of the possible coding candidates performed by the RDO circuitry 115. For example, the RDO circuitry 115 may employ a scale factor, which may be configurable, to bias the override for or against the palette coding candidate based on whether the video content has characteristics of screen content or natural content. Further details concerning the RDO circuitry 115 are provided below.

In the illustrated example of FIG. 1, the palette bit encoder circuitry 120 encodes the palette coding candidate determined for a given coding block. For example, if the encoding type selection output 165 of the RDO circuitry 115 identifies that the palette coding candidate is to be used to encode the given coding block, the palette bit encoder circuitry 120 is invoked by the RDO circuitry 115 to encode the luma palette predictors and the chroma intra predictors of the palette coding candidate to determine encoded luma data and encoded chroma data, respectively, for the given coding block. As such, the palette bit encoder circuitry 120 includes an example encoded luma data output 170 and an example encoded chroma data output 175 to output the encoded luma data and encoded chroma data, respectively, for the given coding block.

In some examples, the palette bit packing circuitry 120 determines the encoded luma data by utilizing run length encoding to encode the palette indexes selected by the palette encoder circuitry 105 for the respective pixels of the given coding block. In some examples, the palette bit packing circuitry 120 also encodes the particular color palette determined by the palette encoder circuitry 105 for the given coding block into the encoded luma data. In some examples, the palette bit packing circuitry 120 employs any appropriate bit encoding technique to encode the luminance component residuals determined by the palette encoder circuitry 105 into the encoded luma data. In some examples, the palette bit packing circuitry 120 employs any appropriate bit encoding technique to encode the chroma intra predictors determined by the prediction encoder circuitry 110 into the encoded chroma data.

As noted above, the example prediction encoder circuitry 110 of FIG. 1 includes the palette search circuitry 125 and the palette map circuitry 130. In the illustrated example, the palette search circuitry 125 implements an example search procedure to determine a color palette for an input coding block of pixels based on a data structures, such as a hash table. In the illustrated example, the palette map circuitry 130 maps the luminance components of the pixels of the coding block respective palette index values based on the color palette. As described above, the palette index values identify colors represented in the color palette.

In some examples, a given coding block to be palette encoded has a size of 16 by 16 (or 16×16) pixels for a total of 265 pixels. As such, the luminance components of the coding block pixels can have up to 256 different luma values. In some examples, the size of the color palette determined by the palette search circuitry 125 is limited to eight (8) colors. As such, the up to 256 different luma values of the coding block pixels are mapped by the palette map circuitry 130 to at most 8 different palette colors. Of course, other coding block sizes and/or color palette sizes can be supported by the palette search circuitry 125 and the palette map circuitry 130.

An example search procedure implemented by the palette search circuitry 125 operates to determine the up to eight (8) colors to include in the color palette to best represent the up to 256 different luma values of the pixels of a given 16×16 coding block. In some examples, the search procedure implemented by the palette search circuitry 125 includes (i) quantizing the luminance components of the pixels of the coding block to determine respective identifiers (e.g., such as hash keys) for the pixels, (ii) populating the data structure (e.g., hash table) based on the identifiers (e.g., hash keys), and (iii) pruning the data structure (e.g., hash table) to determine a color palette for the coding block. The resulting color palette includes up to eight (8) colors indexed by respective palette index values (e.g., values 0 to 7).

In the illustrated example, the palette search circuitry 125 quantizes the luminance components of the coding block pixels based on a configurable hash quantization parameter applied to an example hash quantization input 180 of the palette search circuitry 125. In some examples, the hash quantization parameter is an unsigned 3-bit value that can have a first value, such as a value of 4, or a second value, such as a value of 5, to represent two different levels of quantization to be applied to the luminance components of the coding block pixels. For example, if the luminance components are 8-bit values, the first value of the hash quantization parameter (e.g., 4) may cause the palette search circuitry 125 to right shift the luminance components by a first number of bits corresponding to the first value (e.g., 4 bits in this case), which is equivalent to dividing the luminance components by 2 raised to a power equal to the first value (e.g., 2\hat{ }4=16 in this case). However, the second value of the hash quantization parameter (e.g., 5) may cause the palette search circuitry 125 to right shift the luminance components by a second number of bits corresponding to the second value (e.g., 5 bits in this case), which is equivalent to dividing the luminance components by 2 raised to a power equal to the second value (e.g., 2\hat{ }5=32 in this case). As another example, if the luminance components are 10-bit values, the palette search circuitry 125 may apply an initial right shift of 2 bits (e.g., corresponding to a division of 2\hat{ }2=4) prior to applying the quantization specified by the hash quantization parameter. The resulting quantized luminance components of the coding block pixels form respective hash keys (or, more generally, identifiers) for the pixels. Thus, in the preceding examples, if the hash quantization value has the first value (e.g., 4), the resulting hash keys will be 4 bits supporting up to 16 possible values, whereas if the hash quantization value has the second value (e.g., 5), the resulting hash keys will be 3 bits supporting up to 8 possible values.

In the illustrated example, the palette search circuitry 125 populates a hash table (or any other appropriate data structure, such as a linked list, tree, etc.) based on the hash keys determine for the luminance components of the coding block pixels. For example, the palette search circuitry 125 may scan the pixels of the coding block from in raster order, quantize the luminance components to determine the respective hash keys for the pixels, and add the hash keys to respective entries of the hash table. In some examples, the hash table includes entries for each different hash key value, with the entry for a given hash key value including a count of the number of occurrences of that hash key value among the hash keys determined for the pixels in the given coding block. In some examples, the hash table entry for a given hash key value also includes the full (e.g., 8-bit or 10-bit) unquantized luminance value corresponding to the first scanned pixel that, when its luminance value was quantized, yielded that hash key value. In some examples, the hash table entry for a given hash key value also includes the full (e.g., 8-bit or 10-bit) unquantized luminance value corresponding to an average of the pixel luminance values that, when quantized, yielded that hash key value. As such, the populated hash table represents a candidate color palette with different candidate colors corresponding to the different hash key values.

In the illustrated example, the palette search circuitry 125 prunes the populated hash table to determine a resulting color palette for the coding block. For example, the palette search circuitry 125 prunes the populated hash table based on a first configurable threshold and a second configurable threshold applied to an example first configurable threshold input 185 and a second example configurable threshold 190 of the palette search circuitry 125. In some examples, the first threshold (e.g., referred to as the class0 threshold in FIG. 1) is associated with prevalence of the hash keys in the hash table, whereas the second threshold (e.g., referred to as the class1 threshold in FIG. 1) is associated with uniqueness of the hash keys in the hash table. For example, the palette search circuitry 125 can compare the first threshold to the counts of occurrences of the given hash keys in the hash table to select the most frequently occurring hash keys to become colors to include in the color palette. Additionally or alternatively, the palette search circuitry 125 can compare the second threshold to distances between hash keys represented in the hash table to also select one or more unique hash keys to become colors to include in the color palette.

As described above, in some examples, if the hash quantization value has the first value (e.g., 4), the resulting hash keys will be 4 bits supporting up to 16 possible values, whereas if the hash quantization value has the second value (e.g., 5), the resulting hash keys will be 3 bits supporting up to 8 possible values. As such, if the hash quantization value has the first value (e.g., 4), the resulting hash table may have up to 16 entries, which is greater than the upper limit (e.g., 8) of the number of colors to be included in a color palette. In some such examples, the palette search circuitry 125 prunes the hash table from 16 entries to 8 entries based on the first threshold and the second threshold. The full (e.g., 8-bit or 10-bit) unquantized luminance value stored in the pruned hash table for each retained hash key become the colors of the color palette. In some examples, if the hash quantization value has the second value (e.g., 5), the resulting hash table may have up to 8 entries, which equals the upper limit (e.g., 8) of the number of colors to be included in a color palette. As such, the palette search circuitry 125 may skip the pruning of the hash table in such examples. However, in some examples, the palette search circuitry 125 may still prune the hash table based on the first threshold and the second threshold to yield an even smaller color palette have less than 8 colors, which may yield computational and/or memory resource savings.

In the illustrated example, the palette search circuitry 125 includes an example valid table output 195 to indicate whether hash table pruning was successful (e.g., yielded a pruned hash table having a size that exceeds a valid hash table size corresponding to the upper size limit of 8 colors). If the valid table output 195 indicates hash table pruning is unsuccessful, the palette map circuitry 130 may disable palette coding for the current coding block being encoded. Otherwise, the palette map circuitry 130 maps the luminance components of the pixels to respective palette index values based on the color palette determined by the palette search circuitry 125. In some examples, the palette map circuitry 130 selects the palette index value for a given pixel to correspond to the particular one of up to 8 colors in the color palette that has the smallest absolute pixel difference relative to the luminance component of that pixel.

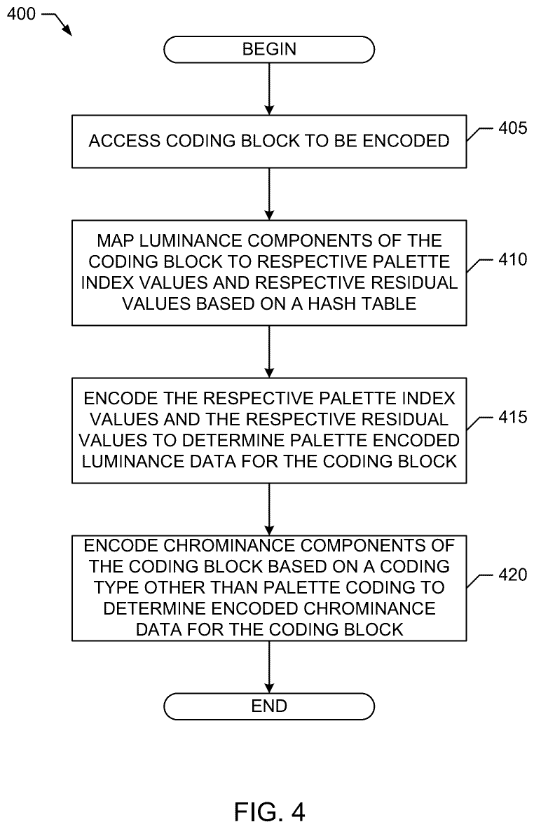

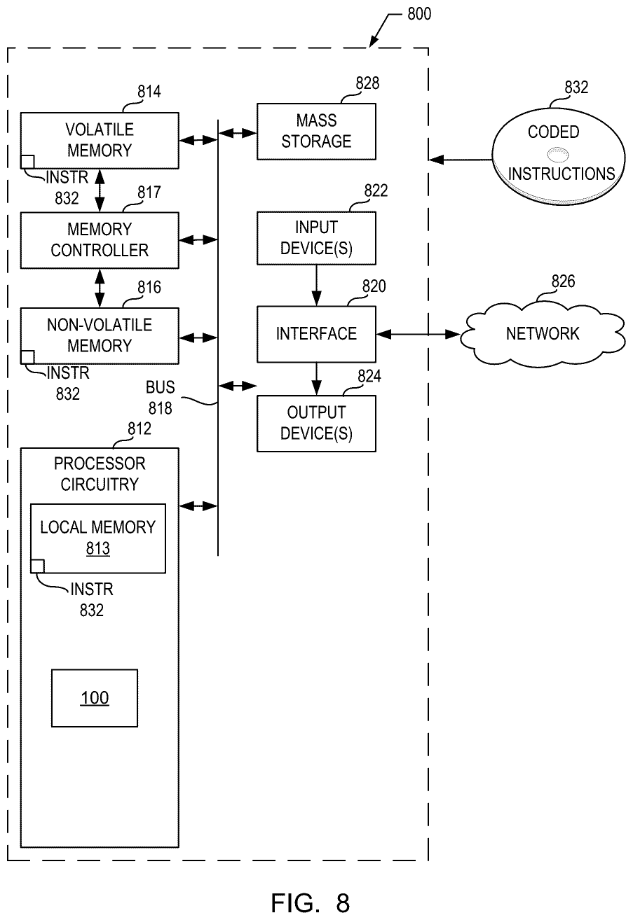

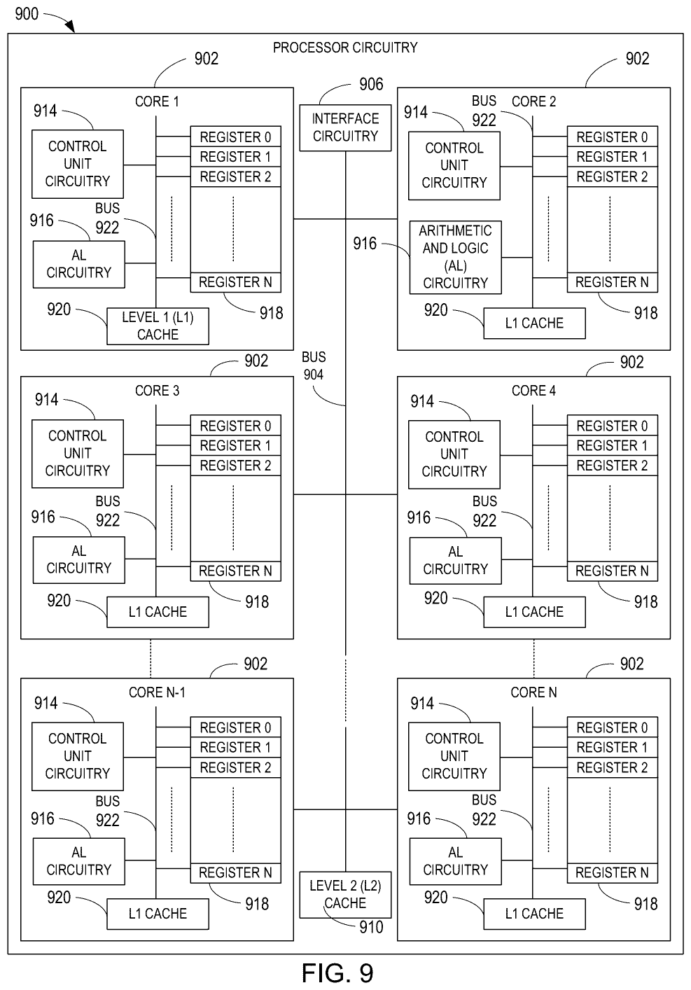

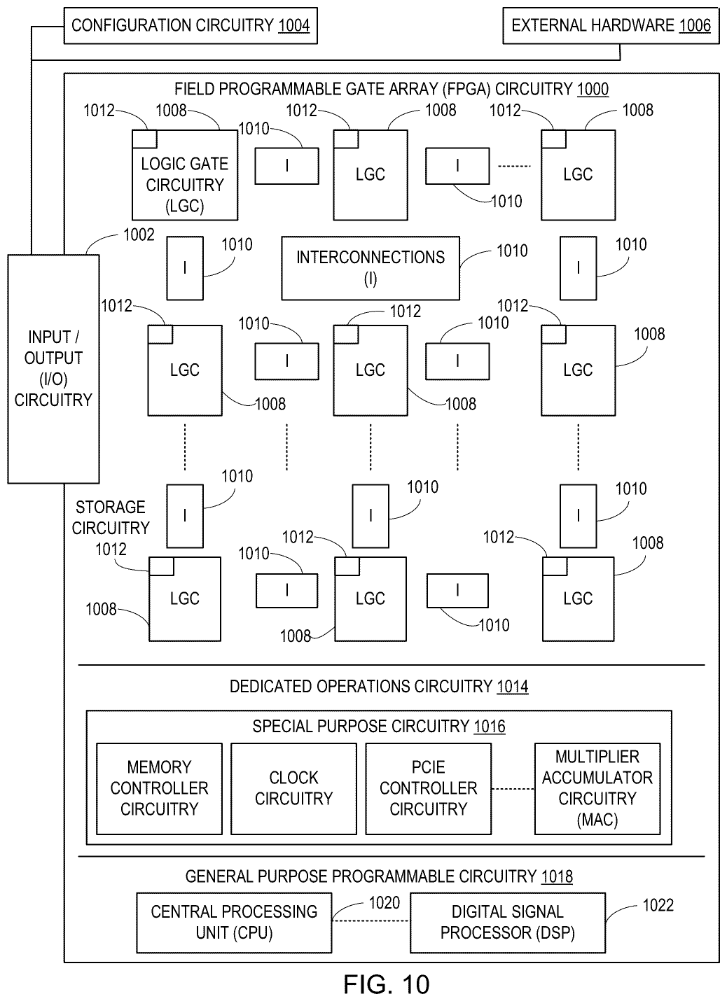

In some examples, the video encoder 100 includes means for palette encoding luminance data. For example, the means for palette encoding may be implemented by the palette encoder circuitry 105. In some examples, the palette encoder circuitry 105 may be instantiated by programmable circuitry such as the example programmable circuitry 812 of FIG. 8. For instance, the palette encoder circuitry 105 may be instantiated by the example microprocessor 900 of FIG. 9 executing machine executable instructions such as those implemented by at least block 410 of FIG. 4. In some examples, the palette encoder circuitry 105 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the palette encoder circuitry 105 may be instantiated by any other combination of hardware, software, and/or firmware. For example, the palette encoder circuitry 105 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the video encoder 100 includes means for encoding chrominance data. For example, the means for encoding chrominance data may be implemented by the prediction encoder circuitry 110. In some examples, the prediction encoder circuitry 110 may be instantiated by programmable circuitry such as the example programmable circuitry 812 of FIG. 8. For instance, the prediction encoder circuitry 110 may be instantiated by the example microprocessor 900 of FIG. 9 executing machine executable instructions such as those implemented by at least block 420 of FIG. 4. In some examples, the prediction encoder circuitry 110 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the prediction encoder circuitry 110 may be instantiated by any other combination of hardware, software, and/or firmware. For example, the prediction encoder circuitry 110 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

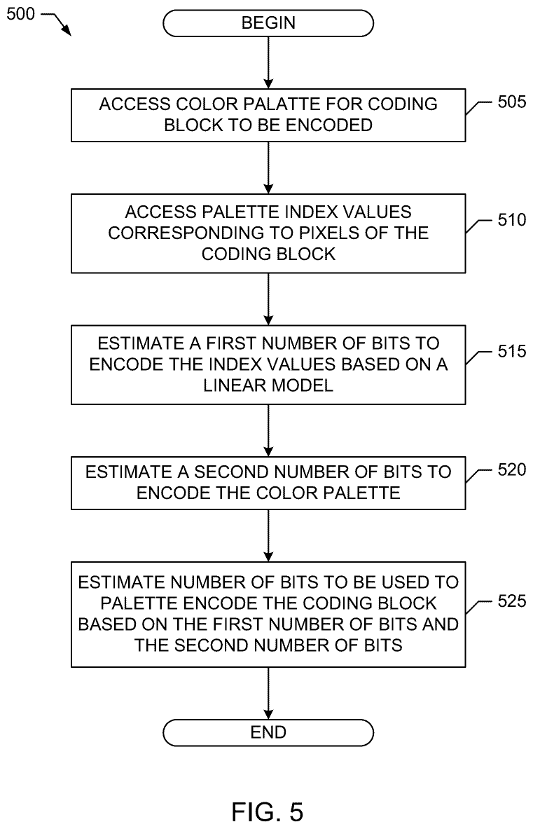

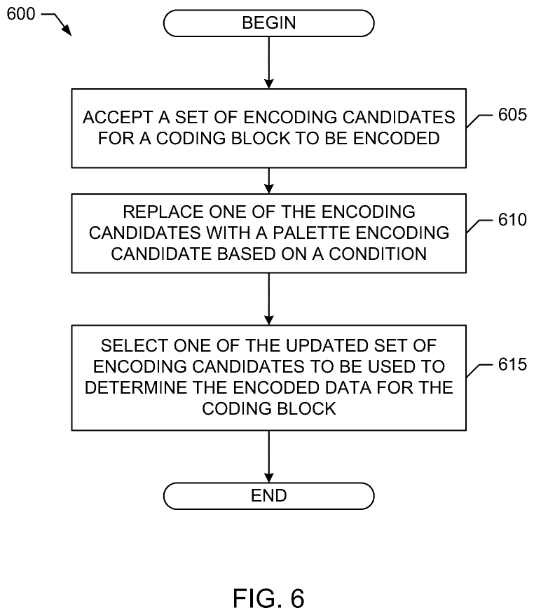

In some examples, the video encoder 100 includes means for performing rate distortion optimization. For example, the means for performing rate distortion optimization may be implemented by the RDO circuitry 115. In some examples, the RDO circuitry 115 may be instantiated by programmable circuitry such as the example programmable circuitry 812 of FIG. 8. For instance, the RDO circuitry 115 may be instantiated by the example microprocessor 900 of FIG. 9 executing machine executable instructions such as those implemented by at least the blocks of FIGS. 5, 6 and/or 7. In some examples, the RDO circuitry 115 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the RDO circuitry 115 may be instantiated by any other combination of hardware, software, and/or firmware. For example, the RDO circuitry 115 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the video encoder 100 includes means for performing palette bit encoding. For example, the means for performing palette bit encoding may be implemented by the palette bit encoder circuitry 120. In some examples, the palette bit encoder circuitry 120 may be instantiated by programmable circuitry such as the example programmable circuitry 812 of FIG. 8. For instance, the palette bit encoder circuitry 120 may be instantiated by the example microprocessor 900 of FIG. 9 executing machine executable instructions such as those implemented by at least blocks 415 and/or 420 of FIG. 4. In some examples, the palette bit encoder circuitry 120 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the palette bit encoder circuitry 120 may be instantiated by any other combination of hardware, software, and/or firmware. For example, the palette bit encoder circuitry 120 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

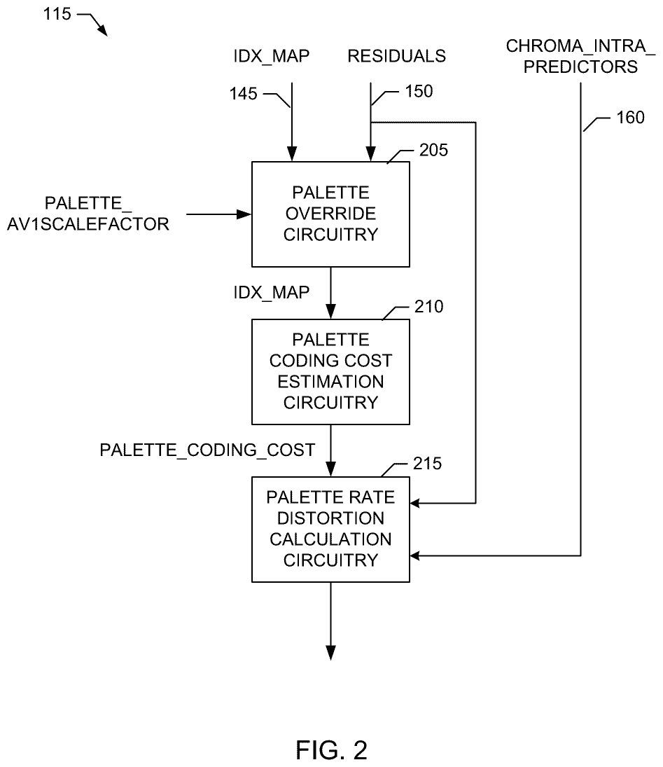

FIG. 2 is a block diagram of an example implementation of the RDO circuitry 115 of FIG. 1. The RDO circuitry 115 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the RDO circuitry 115 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The example RDO circuitry 115 of FIG. 2 includes example palette override circuitry 205, example palette coding cost estimation circuitry 210 and example palette rate distortion calculation circuitry 215. The palette override circuitry 205 of the illustrated example implements an example palette override procedure that replaces another coding type candidate for a given coding block with the palette coding candidate prior to the RDO evaluation of the possible coding candidates performed by the RDO circuitry 115. For example, the palette override circuitry 205 may employ a scale factor, which may be configurable, to bias the override for or against the palette coding candidate based on whether the video content has characteristics of screen content or natural content.

In some examples, the palette override circuitry 205 replaces another coding type candidate for a given coding block with the palette coding candidate based on a condition. For example, the palette override circuitry 205 can replace one of two intra coding candidates for a 16×16 coding block with the palette coding candidate determined by the palette encoder circuitry 105 for that coding block based on the following condition:

### Palette Override Condition

i) If (Palette_Distortion multiplied by Palette_Scalefactor) divided by 16 is less than the distortion value associated with the best intra coding candidate, then replace the second best intra coding candidate with the palette coding candidate;
ii) Otherwise, no change

In the preceding condition, the parameter Palette_Distortion refers to the distortion associated with the palette coding candidate. In some examples, the palette override circuitry 205 determines the palette distortion value as the sum of absolute differences of the residuals included in the palette coding candidate. In some examples, the palette override circuitry 205 determines the palette distortion value based on a sum of transform differences of the residuals included in the palette coding candidate. In some examples, the palette override circuitry 205 determines the palette distortion value based on a sum of the square of the differences of the residuals included in the palette coding candidate. In the preceding condition, the parameter Palette_Scalefactor refers to the scale factor used by the palette override circuitry 205 to bias the palette coding candidate relative to the intra coding candidates. In some examples, the scale factor is an 8-bit unsigned value such that values less than 16 cause the palette override circuitry 205 to bias override for the palette coding candidate, and values greater than 16 cause the palette override circuitry 205 to bias override against the palette coding candidate. In some examples, the palette override circuitry 205 determines the distortion value associated with the intra coding candidates using any appropriate technique.

In some examples, the preceding condition used by the palette override circuitry 205 is generalized as follows. The palette override circuitry 205 replaces, based on a condition, one of a first set coding candidates with a palette coding candidate to determine a second set of coding candidates. In some examples, the first set of coding candidates includes a first coding candidate (e.g., the second best intra coding candidate) and a second coding candidate (e.g., the best intra coding candidate). In some such examples, the palette override circuitry 205 replaces the first coding candidate (e.g., the second best intra coding candidate) with the palette coding candidate based on a first distortion value associated with the palette coding candidate (e.g., Palette_Distortion) being less than a second distortion value associated with the second coding candidate (e.g., the best intra coding candidate). For example, the second distortion value associated with the second coding candidate (e.g., the best intra coding candidate) can be lower that a third distortion value associated with the first coding candidate (e.g., the second best intra coding candidate). In some examples, the palette override circuitry 205 determines or scales the first distortion value associated with the palette coding candidate (e.g., Palette_Distortion) by a scale factor (e.g., Palette_Scalefactor).

In the illustrated example, if the palette override circuitry 205 includes the palette coding candidate in the set of coding candidates for a given coding block through its override procedure, the palette rate distortion calculation circuitry 215 calculates the rate distortion associated with the palette coding candidate for the given coding block. In some examples, the palette rate distortion calculation circuitry 215 calculates the rate distortion associated with the palette coding candidate based on a coding cost associated with the palette coding candidate. In some examples, the palette rate distortion calculation circuitry 215 estimates the coding cost associated with the palette coding candidate based on a combination of a coding cost associated with encoding the luma palette predictors determined by the palette encoder circuitry 105 and a coding cost associated with encoding the chroma intra predicators determined by the prediction encoder circuitry 110 for the given coding block. In some examples, the palette rate distortion calculation circuitry 215 also calculates different rate distortions for the palette coding candidate assuming the residual values included in the luma palette predictors are encoded using discrete cosine transforms vs. using identity transforms.

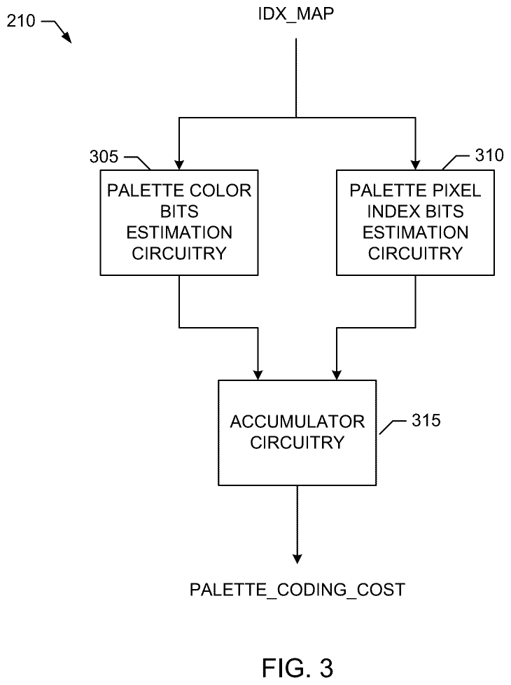

In some examples, the palette rate distortion calculation circuitry 215 estimates the coding cost associated with encoding the luma palette predictors as a combination of a coding cost associated with encoding the color palette and palette indexes (e.g., index map) of the luma palette predictors and a coding cost associated with encoding the residuals of the luma palette predictors. In some such examples, the palette rate distortion calculation circuitry 215 uses any intra coding cost estimation technique to estimate the coding cost associated with encoding the residuals of the luma palette predictors, as well as the coding cost associated with encoding the chroma intra predicators. However, in the illustrated example, the palette rate distortion calculation circuitry 215 obtains an estimate of the coding cost associated with encoding the color palette and palette indexes (e.g., index map) of the luma palette predictors from the palette coding cost estimation circuitry 210. An example implementation of the palette coding cost estimation circuitry 210 is illustrated in FIG. 3, which is described in further detail below.

In some examples, the RDO circuitry 115 includes means for performing palette override. For example, the means for performing palette override may be implemented by the palette override circuitry 205. In some examples, the palette override circuitry 205 may be instantiated by programmable circuitry such as the example programmable circuitry 812 of FIG. 8. For instance, the palette override circuitry 205 may be instantiated by the example microprocessor 900 of FIG. 9 executing machine executable instructions such as those implemented by at least blocks of FIGS. 6 and/or 7. In some examples, the palette override circuitry 205 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the palette override circuitry 205 may be instantiated by any other combination of hardware, software, and/or firmware. For example, the palette override circuitry 205 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the RDO circuitry 115 includes means for performing palette coding cost estimation. For example, the means for performing palette coding cost estimation may be implemented by the palette coding cost estimation circuitry 210. In some examples, the palette coding cost estimation circuitry 210 may be instantiated by programmable circuitry such as the example programmable circuitry 812 of FIG. 8. For instance, the palette coding cost estimation circuitry 210 may be instantiated by the example microprocessor 900 of FIG. 9 executing machine executable instructions such as those implemented by at least blocks of FIG. 5. In some examples, the palette coding cost estimation circuitry 210 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the palette coding cost estimation circuitry 210 may be instantiated by any other combination of hardware, software, and/or firmware. For example, the palette coding cost estimation circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the RDO circuitry 115 includes means for performing palette rate distortion calculation. For example, the means for performing palette rate distortion calculation may be implemented by the palette rate distortion calculation circuitry 215. In some examples, the palette rate distortion calculation circuitry 215 may be instantiated by programmable circuitry such as the example programmable circuitry 812 of FIG. 8. For instance, the palette rate distortion calculation circuitry 215 may be instantiated by the example microprocessor 900 of FIG. 9 executing machine executable instructions. In some examples, the palette rate distortion calculation circuitry 215 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the palette rate distortion calculation circuitry 215 may be instantiated by any other combination of hardware, software, and/or firmware. For example, the palette rate distortion calculation circuitry 215 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

FIG. 3 is a block diagram of an example implementation of the palette coding cost estimation circuitry 210 of FIG. 2. The palette coding cost estimation circuitry 210 of FIG. 3 may be instantiated (e.g., creating an instance of, bring into being for any length of time, materialize, implement, etc.) by programmable circuitry such as a Central Processor Unit (CPU) executing first instructions. Additionally or alternatively, the palette coding cost estimation circuitry 210 of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers.

The example palette coding cost estimation circuitry 210 of FIG. 3 includes example palette color bits estimation circuitry 305, example palette pixel index bits estimation circuitry 310, and example accumulator circuitry 315. The palette color bits estimation circuitry 305 of the illustrated example estimates a number of bits to encode a color palette used to palette encode a coding block of pixels. For example, the palette color bits estimation circuitry 305 estimates the number of bits to encode the color palette by estimating a number of bits to encode the color values of the color palette. In some examples, the palette color bits estimation circuitry 305 estimates the number of bits to encode the color values of the color palette be a total of (i) a first number of bits to encode the full (e.g., 8-bit or 10-bit) value associated with a first color in the color palette and (ii) respective numbers of bits to encode differences between successive pairs of colors in the color palette. For example, if the color palette includes 8 colors, the palette color bits estimation circuitry 305 may estimate the number of bits to encode the color values of the color palette by adding the number of bits to encode the first color value of the palette at full resolution (e.g., 8-bit or 10-bit) with 7 other numbers of bits to be used to encode the respective differences between the 7 successive pairs of colors in the color palette (e.g., a number of bits to encode the difference between the second color and the first color added to a number of bits to encode the difference between the third color and the second color, and so on). Stated another way, in some examples, the palette color bits estimation circuitry 305 estimates the number of bits to encode the color values of the color palette based on a number of bits to encode a first color in the color palette and respective numbers of bits to encode differences between successive pairs of color in the color palette. Also, in some examples, the palette color bits estimation circuitry 305 estimates the number of bits to encode the color values of the color palette without accounting for possible coding efficiencies that can be achieved by reusing the coding applied to neighbor blocks.

In the illustrated example of FIG. 3, the example palette pixel index bits estimation circuitry 310 estimates the number of bits to encode the palette index values corresponding respectively to the pixels of a coding block encoded by the palette encoder circuitry 105. The palette pixel index bits estimation circuitry 310 estimates the number of bits to encode the palette index values based on a linear model (or another type of regression model, such as a quadratic model). In some examples, the palette pixel index bits estimation circuitry 310 determines the linear model based on configuration parameters including an offset value and a set of coefficient values. In some examples, the palette pixel index bits estimation circuitry 310 determines the linear model based on configuration parameters including the offset value, the set of coefficient values, and a width of the coding block and a height of the coding block.

In some examples, the palette pixel index bits estimation circuitry 310 compares the palette index values for different neighbor pixels of the coding block to determine a first count value and a second count value, and evaluates the linear model based on the first count value, the second count value and the configuration parameters to estimate the number of bits to encode the palette index values for the coding block. For example, the palette pixel index bits estimation circuitry 310 may scan the pixels of the coding block in raster order and increment the first count value based on a given scanned pixel and a left neighbor pixel of the given scanned pixel having same palette index values. In some such examples, the palette pixel index bits estimation circuitry 310 may also increment the second count value based on (i) a given scanned pixel and a left neighbor pixel of the second scanned pixel having different palette index values and (ii) the given scanned pixel and an upper neighbor pixel of the given scanned pixel having same palette index values.

For example, the palette pixel index bits estimation circuitry 310 may scan the pixels of the coding block in raster order beginning with the top left pixel. Then, for each scanned pixel, the palette pixel index bits estimation circuitry 310 compares the palette index value of the left neighbor pixel (if it exists) with palette index value of the given scanned pixel. If the palette index values are the same, the palette pixel index bits estimation circuitry 310 increases the first count value (e.g., represented by numIdx0 in the linear model below) by one. However, if those palette index values are different, the palette pixel index bits estimation circuitry 310 compares the palette index value of the top neighbor pixel (if it exists) with palette index value of the given scanned pixel PLT index. If the palette index values are the same, the palette pixel index bits estimation circuitry 310 increases the second count value (e.g., represented by numIdx1 in the linear model below) by one.

Next, after all pixels are scanned, the palette pixel index bits estimation circuitry 310 compares the first count value (e.g., numIdx0) and the second count value (e.g., numIdx1). If the second count value (e.g., numIdx1) is greater than the first count value (e.g., numIdx0), the palette pixel index bits estimation circuitry 310 swaps the first count value (e.g., numIdx0) and the second count value (e.g., numIdx1).

Next, the palette pixel index bits estimation circuitry 310 uses the first count value (e.g., numIdx0) and the second count value (e.g., numIdx1) to evaluate the linear model of Equation 1 to estimate the number of bits to encode the palette index values of the coding block. Equation 1 is:

$$numBits = FIRST\_INDEX + ( ( AV1\_INDEX \_MAP \_COEF1 * numIdx 0 + AV1\_INDEX \text{} \_MAP \_COEF1 * numIdx 1 + AV1\_INDEX \text{} \_MAP \text{} \_COEF2 * ( width * height - ( numIdx 0 + numIdx 1 ) ) ) >> 4 ) \qquad Equation 1$$

In Equation 1, FIRST_INDEX is the offset value of the linear model and AV1_INDEX_MAP_COEF0, AV1_INDEX_MAP_COEF1, AV1_INDEX_MAP_COEF2 are the set of coefficient values of the linear model. In some examples, the offset value and the set of coefficient values are set to the following values:

$$FIRST\_INDEX = 3 ; \\ AV1\_INDEX \_MAP \_COEF0 = 0 ; \\ AV1\_INDEX \_MAP \_COEF1 = 15 ; and$$

$$AV1\_INDEX \_MAP \_COEF2 = 92 .$$

In Equation 1, the values of width and height are each 16, which corresponds to the 16×16 coding block size.

In the illustrated example of FIG. 3, the accumulator circuitry 315 adds the number of bits determined by the palette color bits estimation circuitry 305 and the number of bits determined by the palette pixel index bits estimation circuitry 310 to estimate the number of bits (e.g., coding cost) associated with encoding the color palette and palette indexes (e.g., index map) of the luma palette predictors for the given coding block. In some examples, the RDO circuitry 115 uses the number of bits (e.g., coding cost) output by the accumulator circuitry 315 to determine whether to palette encode the given coding block.

In some examples, the palette coding cost estimation circuitry 210 includes means for estimating a number of bits to encode a color palette. For example, the means for estimating a number of bits to encode a color palette may be implemented by the palette color bits estimation circuitry 305. In some examples, the palette color bits estimation circuitry 305 may be instantiated by programmable circuitry such as the example programmable circuitry 812 of FIG. 8. For instance, the palette color bits estimation circuitry 305 may be instantiated by the example microprocessor 900 of FIG. 9 executing machine executable instructions such as those implemented by at least blocks 505, 520 of FIG. 5. In some examples, the palette color bits estimation circuitry 305 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the palette color bits estimation circuitry 305 may be instantiated by any other combination of hardware, software, and/or firmware. For example, the palette color bits estimation circuitry 305 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the palette coding cost estimation circuitry 210 includes means for estimating a number of bits to encode color palette indexes of a coding block. For example, the means for estimating a number of bits to encode color palette indexes may be implemented by the palette pixel index bits estimation circuitry 310. In some examples, the palette pixel index bits estimation circuitry 310 may be instantiated by programmable circuitry such as the example programmable circuitry 812 of FIG. 8. For instance, the palette pixel index bits estimation circuitry 310 may be instantiated by the example microprocessor 900 of FIG. 9 executing machine executable instructions such as those implemented by at least blocks 510, 515 of FIG. 5. In some examples, the palette pixel index bits estimation circuitry 310 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the palette pixel index bits estimation circuitry 310 may be instantiated by any other combination of hardware, software, and/or firmware. For example, the palette pixel index bits estimation circuitry 310 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the palette coding cost estimation circuitry 210 includes means for estimating a number of bits to palette encode a coding block. For example, the means for estimating a number of bits to palette encode a coding block may be implemented by the accumulator circuitry 315. In some examples, the accumulator circuitry 315 may be instantiated by programmable circuitry such as the example programmable circuitry 812 of FIG. 8. For instance, the accumulator circuitry 315 may be instantiated by the example microprocessor 900 of FIG. 9 executing machine executable instructions such as those implemented by at least block 525 of FIG. 5. In some examples, the accumulator circuitry 315 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the accumulator circuitry 315 may be instantiated by any other combination of hardware, software, and/or firmware. For example, the accumulator circuitry 315 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the video encoder 100 is illustrated in FIGS. 1-3, one or more of the elements, processes, and/or devices illustrated in FIGS. 1-3 may be combined, divided, re-arranged, omitted, eliminated, and/or implemented in any other way. Further, the example palette encoder circuitry 105, the example prediction encoder circuitry 110, the example rate distortion optimization circuitry 115, the example palette bit encoder circuitry 120, the example palette search circuitry 125, the example palette map circuitry 130, the example palette override circuitry 205, the example palette coding cost estimation circuitry 210, the example palette rate distortion calculation circuitry 215, the example palette color bits estimation circuitry 305, the example palette pixel index bits estimation circuitry 310, the example accumulator circuitry 315 and/or, more generally, the example video encoder 100 of FIGS. 1-3, may be implemented by hardware alone or by hardware in combination with software and/or firmware. Thus, for example, any of the example palette encoder circuitry 105, the example prediction encoder circuitry 110, the example rate distortion optimization circuitry 115, the example palette bit encoder circuitry 120, the example palette search circuitry 125, the example palette map circuitry 130, the example palette override circuitry 205, the example palette coding cost estimation circuitry 210, the example palette rate distortion calculation circuitry 215, the example palette color bits estimation circuitry 305, the example palette pixel index bits estimation circuitry 310, the example accumulator circuitry 315 and/or, more generally, the example the example video encoder 100, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example the example video encoder 100 may include one or more elements, processes, and/or devices in addition to, or instead of, those illustrated in FIGS. 1-3, and/or may include more than one of any or all of the illustrated elements, processes and devices.

Flowchart(s) representative of example machine readable instructions, which may be executed by programmable circuitry to implement and/or instantiate the example video encoder 100 of FIGS. 1-3 and/or representative of example operations which may be performed by programmable circuitry to implement and/or instantiate the example video encoder 100 of FIGS. 1-3, are shown in FIGS. 4-7. The machine readable instructions may be one or more executable programs or portion(s) of one or more executable programs for execution by programmable circuitry such as the programmable circuitry 812 shown in the example processor platform 800 discussed below in connection with FIG. 8 and/or may be one or more function(s) or portion(s) of functions to be performed by the example programmable circuitry (e.g., an FPGA) discussed below in connection with FIGS. 9 and/or 10. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 4-7, many other methods of implementing the example video encoder 100 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 4-7 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 4 is a flowchart representative of example machine readable instructions and/or example operations 400 that may be executed, instantiated, and/or performed by programmable circuitry to implement the video encoder 100. The example machine-readable instructions and/or the example operations 400 of FIG. 4 begin at block 405, at which interface circuitry of the video encoder 100 accesses a coding block to be encoded. At block 410, the palette encoder circuitry 105 of the video encoder 100 maps luminance components of the coding block to respective palette index values and respective residual values based on a hash table, as described above. At block 415, the palette bit encoder circuitry 120 of the video encoder 100 encodes the respective palette index values and the respective residual values to determine palette encoded luminance data for the coding block, as described above. At block 420, the prediction encoder circuitry 110 and the palette bit encoder circuitry 120 of the video encoder 100 encode chrominance components of the coding block based on a coding type other than palette coding (e.g., such as intra coding) to determine encoded chrominance data for the coding block, as described above. The machine-readable instructions and/or the example operations 400 then end.

FIG. 5 is a flowchart representative of example machine readable instructions and/or example operations 500 that may be executed, instantiated, and/or performed by programmable circuitry to implement the palette coding cost estimation circuitry 210 included in the video encoder 100. The example machine-readable instructions and/or the example operations 500 of FIG. 5 begin at block 505, at which the palette color bits estimation circuitry 305 of the palette coding cost estimation circuitry 210 accesses a color palette determined for a given coding block to be encoded, as described above. At block 510, the palette pixel index bits estimation circuitry 310 of the palette coding cost estimation circuitry 210 accesses the palette index values determined for the pixels of given coding block, as described above. At block 515, the palette pixel index bits estimation circuitry 310 estimates, based on a linear model, a first number of bits to encode the palette index values, as described above. At block 520, the palette color bits estimation circuitry 305 estimates a second number of bits to encode the color palette, as described above. At block 525, the accumulator circuitry 315 of the palette coding cost estimation circuitry 210 estimates a number of bits to be used to palette encode the coding block based on the first number of bits determined at block 515 and the second number of bits determined at block 520, as described above. The machine-readable instructions and/or the example operations 500 then end.

FIG. 6 is a flowchart representative of first example machine readable instructions and/or example operations 600 that may be executed, instantiated, and/or performed by programmable circuitry to implement the RDO circuitry 115 included in the video encoder 100. The example machine-readable instructions and/or the example operations 600 of FIG. 6 begin at block 605, at which the RDO circuitry 115 accepts a set of coding candidates for a coding block to be encoded, as described above. At block 610, the palette override circuitry 205 of the RDO circuitry 115 replaces, based on a condition, one of the coding candidates with a palette coding candidate, as described above. At block 615, the RDO circuitry 115 selects one of the coding candidates in the updated set of coding candidates to be used to determine the encoded data for the coding block, as described above. The machine-readable instructions and/or the example operations 600 then end.

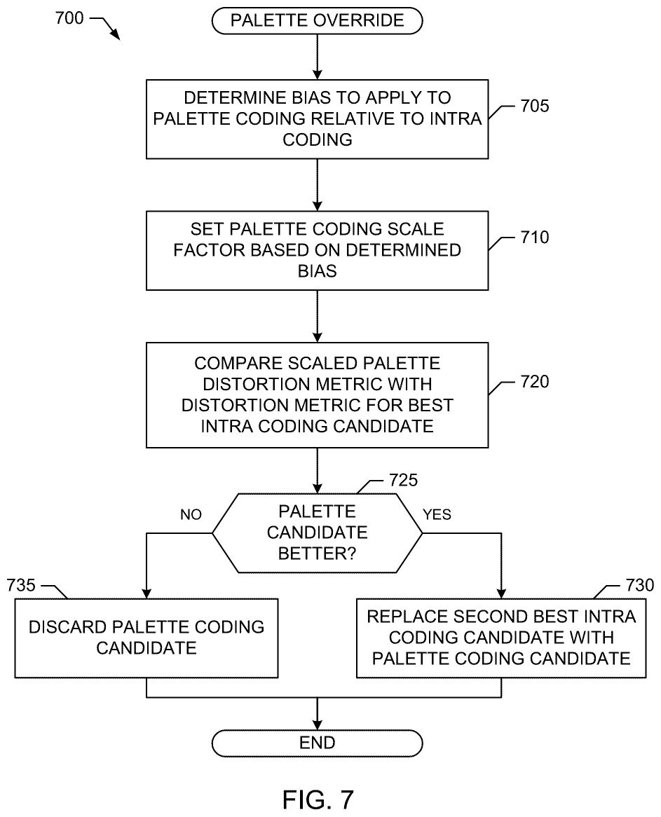

FIG. 7 is a flowchart representative of example machine readable instructions and/or example operations 700 that may be executed, instantiated, and/or performed by programmable circuitry to implement the palette override circuitry 205 included in the video encoder 100. The example machine-readable instructions and/or the example operations 700 of FIG. 7 begin at block 705, at which the palette override circuitry 205 determines a bias to apply to palette coding relative to intra coding for a given coding block. At block 710, the palette override circuitry 205 sets a palette coding scale factory based on the bias determined at block 705. At block 720, the palette override circuitry 205 compares a scaled palette distortion metric determined for a palette coding candidate for the coding block with a distortion metric for a best intra coding candidate for the coding block, as described above. If, at block 725, the scaled palette distortion metric indicates the palette candidate has better (e.g., lower) distortion, at block 730 the palette override circuitry 205 replaces the second best intra coding candidate for the coding block with the palette coding candidate, as described above. Otherwise, at block 735, the palette override circuitry discards the palette coding candidate. The machine-readable instructions and/or the example operations 700 then end.

FIG. 8 is a block diagram of an example programmable circuitry platform 800 structured to execute and/or instantiate the example machine-readable instructions and/or the example operations of FIGS. 4-7 to implement the video encoder 100 of FIGS. 1-3. The programmable circuitry platform 800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 800 of the illustrated example includes programmable circuitry 812. The programmable circuitry 812 of the illustrated example is hardware. For example, the programmable circuitry 812 can be implemented by one or more integrated circuits, logic circuits, FPGAs, microprocessors, CPUs, GPUs, DSPs, and/or microcontrollers from any desired family or manufacturer. The programmable circuitry 812 may be implemented by one or more semiconductor based (e.g., silicon based) devices. In this example, the programmable circuitry 812 implements the example palette encoder circuitry 105, the example prediction encoder circuitry 110, the example rate distortion optimization circuitry 115, the example palette bit encoder circuitry 120, the example palette search circuitry 125, the example palette map circuitry 130, the example palette override circuitry 205, the example palette coding cost estimation circuitry 210, the example palette rate distortion calculation circuitry 215, the example palette color bits estimation circuitry 305, the example palette pixel index bits estimation circuitry 310, the example accumulator circuitry 315 and/or, more generally, the example video encoder 100.

The programmable circuitry 812 of the illustrated example includes a local memory 813 (e.g., a cache, registers, etc.). The programmable circuitry 812 of the illustrated example is in communication with main memory 814, 816, which includes a volatile memory 814 and a non-volatile memory 816, by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817. In some examples, the memory controller 817 may be implemented by one or more integrated circuits, logic circuits, microcontrollers from any desired family or manufacturer, or any other type of circuitry to manage the flow of data going to and from the main memory 814, 816.

The programmable circuitry platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 822 are connected to the interface circuitry 820. The input device(s) 822 permit(s) a user (e.g., a human user, a machine user, etc.) to enter data and/or commands into the programmable circuitry 812. The input device(s) 822 can be implemented by, for example, an audio sensor, a microphone, a camera (still or video), a keyboard, a button, a mouse, a touchscreen, a trackpad, a trackball, an isopoint device, and/or a voice recognition system.

One or more output devices 824 are also connected to the interface circuitry 820 of the illustrated example. The output device(s) 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 800 of the illustrated example also includes one or more mass storage discs or devices 828 to store firmware, software, and/or data. Examples of such mass storage discs or devices 828 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 832, which may be implemented by the machine readable instructions of FIGS. 4-7, may be stored in the mass storage device 828, in the volatile memory 814, in the non-volatile memory 816, and/or on at least one non-transitory computer readable storage medium such as a CD or DVD which may be removable.

FIG. 9 is a block diagram of an example implementation of the programmable circuitry 812 of FIG. 8. In this example, the programmable circuitry 812 of FIG. 8 is implemented by a microprocessor 900. For example, the microprocessor 900 may be a general-purpose microprocessor (e.g., general-purpose microprocessor circuitry). The microprocessor 900 executes some or all of the machine-readable instructions of the flowcharts of FIGS. 4-7 to effectively instantiate the circuitry of FIG. 1 as logic circuits to perform operations corresponding to those machine readable instructions. In some such examples, the circuitry of FIG. 1 is instantiated by the hardware circuits of the microprocessor 900 in combination with the machine-readable instructions. For example, the microprocessor 900 may be implemented by multi-core hardware circuitry such as a CPU, a DSP, a GPU, an XPU, etc. Although it may include any number of example cores 902 (e.g., 1 core), the microprocessor 900 of this example is a multi-core semiconductor device including N cores. The cores 902 of the microprocessor 900 may operate independently or may cooperate to execute machine readable instructions. For example, machine code corresponding to a firmware program, an embedded software program, or a software program may be executed by one of the cores 902 or may be executed by multiple ones of the cores 902 at the same or different times. In some examples, the machine code corresponding to the firmware program, the embedded software program, or the software program is split into threads and executed in parallel by two or more of the cores 902. The software program may correspond to a portion or all of the machine readable instructions and/or operations represented by the flowcharts of FIGS. 4-7.

The cores 902 may communicate by a first example bus 904. In some examples, the first bus 904 may be implemented by a communication bus to effectuate communication associated with one(s) of the cores 902. For example, the first bus 904 may be implemented by at least one of an Inter-Integrated Circuit (I2C) bus, a Serial Peripheral Interface (SPI) bus, a PCI bus, or a PCIe bus. Additionally or alternatively, the first bus 904 may be implemented by any other type of computing or electrical bus. The cores 902 may obtain data, instructions, and/or signals from one or more external devices by example interface circuitry 906. The cores 902 may output data, instructions, and/or signals to the one or more external devices by the interface circuitry 906. Although the cores 902 of this example include example local memory 920 (e.g., Level 1 (L1) cache that may be split into an L1 data cache and an L1 instruction cache), the microprocessor 900 also includes example shared memory 910 that may be shared by the cores (e.g., Level 2 (L2 cache)) for high-speed access to data and/or instructions. Data and/or instructions may be transferred (e.g., shared) by writing to and/or reading from the shared memory 910. The local memory 920 of each of the cores 902 and the shared memory 910 may be part of a hierarchy of storage devices including multiple levels of cache memory and the main memory (e.g., the main memory 814, 816 of FIG. 8). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 902 may be referred to as a CPU, DSP, GPU, etc., or any other type of hardware circuitry. Each core 902 includes control unit circuitry 914, arithmetic and logic (AL) circuitry (sometimes referred to as an ALU) 916, a plurality of registers 918, the local memory 920, and a second example bus 922. Other structures may be present. For example, each core 902 may include vector unit circuitry, single instruction multiple data (SIMD) unit circuitry, load/store unit (LSU) circuitry, branch/jump unit circuitry, floating-point unit (FPU) circuitry, etc. The control unit circuitry 914 includes semiconductor-based circuits structured to control (e.g., coordinate) data movement within the corresponding core 902. The AL circuitry 916 includes semiconductor-based circuits structured to perform one or more mathematic and/or logic operations on the data within the corresponding core 902. The AL circuitry 916 of some examples performs integer based operations. In other examples, the AL circuitry 916 also performs floating-point operations. In yet other examples, the AL circuitry 916 may include first AL circuitry that performs integer-based operations and second AL circuitry that performs floating-point operations. In some examples, the AL circuitry 916 may be referred to as an Arithmetic Logic Unit (ALU).

The registers 918 are semiconductor-based structures to store data and/or instructions such as results of one or more of the operations performed by the AL circuitry 916 of the corresponding core 902. For example, the registers 918 may include vector register(s), SIMD register(s), general-purpose register(s), flag register(s), segment register(s), machine-specific register(s), instruction pointer register(s), control register(s), debug register(s), memory management register(s), machine check register(s), etc. The registers 918 may be arranged in a bank as shown in FIG. 9. Alternatively, the registers 918 may be organized in any other arrangement, format, or structure, such as by being distributed throughout the core 902 to shorten access time. The second bus 922 may be implemented by at least one of an I2C bus, a SPI bus, a PCI bus, or a PCIe bus.

Each core 902 and/or, more generally, the microprocessor 900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 900 is a semiconductor device fabricated to include many transistors interconnected to implement the structures described above in one or more integrated circuits (ICs) contained in one or more packages.

The microprocessor 900 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 900, in the same chip package as the microprocessor 900 and/or in one or more separate packages from the microprocessor 900.

FIG. 10 is a block diagram of another example implementation of the programmable circuitry 812 of FIG. 8. In this example, the programmable circuitry 812 is implemented by FPGA circuitry 1000. For example, the FPGA circuitry 1000 may be implemented by an FPGA. The FPGA circuitry 1000 can be used, for example, to perform operations that could otherwise be performed by the example microprocessor 900 of FIG. 9 executing corresponding machine readable instructions. However, once configured, the FPGA circuitry 1000 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 900 of FIG. 9 described above (which is a general purpose device that may be programmed to execute some or all of the machine readable instructions represented by the flowchart(s) of FIGS. 4-7 but whose interconnections and logic circuitry are fixed once fabricated), the FPGA circuitry 1000 of the example of FIG. 10 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 4-7. In particular, the FPGA circuitry 1000 may be thought of as an array of logic gates, interconnections, and switches. The switches can be programmed to change how the logic gates are interconnected by the interconnections, effectively forming one or more dedicated logic circuits (unless and until the FPGA circuitry 1000 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 4-7. As such, the FPGA circuitry 1000 may be configured and/or structured to effectively instantiate some or all of the operations/functions corresponding to the machine readable instructions of the flowchart(s) of FIGS. 4-7 as dedicated logic circuits to perform the operations/functions corresponding to those software instructions in a dedicated manner analogous to an ASIC. Therefore, the FPGA circuitry 1000 may perform the operations/functions corresponding to the some or all of the machine readable instructions of FIGS. 4-7 faster than the general-purpose microprocessor can execute the same.

In the example of FIG. 10, the FPGA circuitry 1000 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

The FPGA circuitry 1000 of FIG. 10, includes example input/output (I/O) circuitry 1002 to obtain and/or output data to/from example configuration circuitry 1004 and/or external hardware 1006. For example, the configuration circuitry 1004 may be implemented by interface circuitry that may obtain a binary file, which may be implemented by a bit stream, data, and/or machine-readable instructions, to configure the FPGA circuitry 1000, or portion(s) thereof. In some such examples, the configuration circuitry 1004 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1006 may be implemented by external hardware circuitry. For example, the external hardware 1006 may be implemented by the microprocessor 900 of FIG. 9.

The FPGA circuitry 1000 also includes an array of example logic gate circuitry 1008, a plurality of example configurable interconnections 1010, and example storage circuitry 1012. The logic gate circuitry 1008 and the configurable interconnections 1010 are configurable to instantiate one or more operations/functions that may correspond to at least some of the machine readable instructions of FIGS. 4-7 and/or other desired operations. The logic gate circuitry 1008 shown in FIG. 10 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1008 to enable configuration of the electrical structures and/or the logic gates to form circuits to perform desired operations/functions. The logic gate circuitry 1008 may include other electrical structures such as look-up tables (LUTs), registers (e.g., flip-flops or latches), multiplexers, etc.

The configurable interconnections 1010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1008 to program desired logic circuits.

The storage circuitry 1012 of the illustrated example is structured to store result(s) of the one or more of the operations performed by corresponding logic gates. The storage circuitry 1012 may be implemented by registers or the like. In the illustrated example, the storage circuitry 1012 is distributed amongst the logic gate circuitry 1008 to facilitate access and increase execution speed.

The example FPGA circuitry 1000 of FIG. 10 also includes example dedicated operations circuitry 1014. In this example, the dedicated operations circuitry 1014 includes special purpose circuitry 1016 that may be invoked to implement commonly used functions to avoid the need to program those functions in the field. Examples of such special purpose circuitry 1016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1000 may also include example general purpose programmable circuitry 1018 such as an example CPU 1020 and/or an example DSP 1022. Other general purpose programmable circuitry 1018 may additionally or alternatively be present such as a GPU, an XPU, etc., that can be programmed to perform other operations.

Although FIGS. 9 and 10 illustrate two example implementations of the programmable circuitry 812 of FIG. 8, many other approaches are contemplated. For example, FPGA circuitry may include an on-board CPU, such as one or more of the example CPU 1020 of FIG. 9. Therefore, the programmable circuitry 812 of FIG. 8 may additionally be implemented by combining at least the example microprocessor 900 of FIG. 9 and the example FPGA circuitry 1000 of FIG. 10. In some such hybrid examples, one or more cores 902 of FIG. 9 may execute a first portion of the machine readable instructions represented by the flowchart(s) of FIGS. 4-7 to perform first operation(s)/function(s), the FPGA circuitry 1000 of FIG. 10 may be configured and/or structured to perform second operation(s)/function(s) corresponding to a second portion of the machine readable instructions represented by the flowcharts of FIG. 4-7, and/or an ASIC may be configured and/or structured to perform third operation(s)/function(s) corresponding to a third portion of the machine readable instructions represented by the flowcharts of FIGS. 4-7.

It should be understood that some or all of the circuitry of FIG. 1 may, thus, be instantiated at the same or different times. For example, same and/or different portion(s) of the microprocessor 900 of FIG. 9 may be programmed to execute portion(s) of machine-readable instructions at the same and/or different times. In some examples, same and/or different portion(s) of the FPGA circuitry 1000 of FIG. 10 may be configured and/or structured to perform operations/functions corresponding to portion(s) of machine-readable instructions at the same and/or different times.

In some examples, some or all of the circuitry of FIG. 1 may be instantiated, for example, in one or more threads executing concurrently and/or in series. For example, the microprocessor 900 of FIG. 9 may execute machine readable instructions in one or more threads executing concurrently and/or in series. In some examples, the FPGA circuitry 1000 of FIG. 10 may be configured and/or structured to carry out operations/functions concurrently and/or in series. Moreover, in some examples, some or all of the circuitry of FIG. 1 may be implemented within one or more virtual machines and/or containers executing on the microprocessor 900 of FIG. 9.

In some examples, the programmable circuitry 812 of FIG. 8 may be in one or more packages. For example, the microprocessor 900 of FIG. 9 and/or the FPGA circuitry 1000 of FIG. 10 may be in one or more packages. In some examples, an XPU may be implemented by the programmable circuitry 812 of FIG. 8, which may be in one or more packages. For example, the XPU may include a CPU (e.g., the microprocessor 900 of FIG. 9, the CPU 1020 of FIG. 10, etc.) in one package, a DSP (e.g., the DSP 1022 of FIG. 10) in another package, a GPU in yet another package, and an FPGA (e.g., the FPGA circuitry 1000 of FIG. 10) in still yet another package.

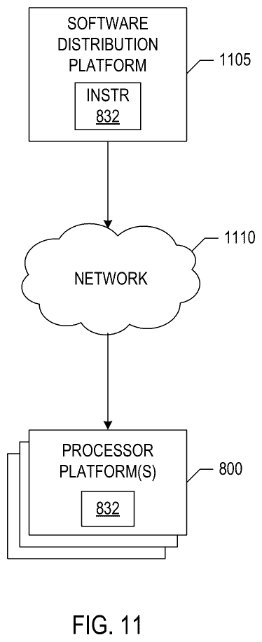

A block diagram illustrating an example software distribution platform 1105 to distribute software such as the example machine readable instructions 832 of FIG. 8 to other hardware devices (e.g., hardware devices owned and/or operated by third parties from the owner and/or operator of the software distribution platform) is illustrated in FIG. 11. The example software distribution platform 1105 may be implemented by any computer server, data facility, cloud service, etc., capable of storing and transmitting software to other computing devices. The third parties may be customers of the entity owning and/or operating the software distribution platform 1105. For example, the entity that owns and/or operates the software distribution platform 1105 may be a developer, a seller, and/or a licensor of software such as the example machine readable instructions 832 of FIG. 8. The third parties may be consumers, users, retailers, OEMs, etc., who purchase and/or license the software for use and/or re-sale and/or sub-licensing. In the illustrated example, the software distribution platform 1105 includes one or more servers and one or more storage devices. The storage devices store the machine readable instructions 832, which may correspond to the example machine readable instructions of FIGS. 4-7, as described above. The one or more servers of the example software distribution platform 1105 are in communication with an example network 1110, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 832 from the software distribution platform 1105. For example, the software, which may correspond to the example machine readable instructions of FIG. 4-7, may be downloaded to the example programmable circuitry platform 800, which is to execute the machine readable instructions 832 to implement the video encoder 100. In some examples, one or more servers of the software distribution platform 1105 periodically offer, transmit, and/or force updates to the software (e.g., the example machine readable instructions 832 of FIG. 8) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that implement palette intra prediction for video encoding. Example systems, apparatus, articles of manufacture, and methods disclosed herein improve the efficiency of using a computing device by simplifying and modifying prior palette-based encoding techniques to achieve AV1-compliant palette coding but with reduced computational and/or memory utilization relative to prior techniques. For example, some palette intra prediction coding examples disclosed herein limit palette encoding to one video component, such as the luminance component of the video, and utilize another video coding type, such as intra coding, to encode the chrominance components of the video. In this way, the different possible combinations of coding types to be evaluated by the video encoder are reduced, thereby simplifying video encoder operation and yielding computational and memory resource savings. Also, in some palette intra prediction coding examples disclosed herein, palette coding cost is estimated for a given coding block based on a linear model that is evaluated using the palette index values used to encode the given coding block. This linear model technique can be simpler than other cost estimation techniques, resulting in computational and memory resource savings. Also, some palette intra prediction coding examples disclosed herein implement a palette override procedure that replaces another coding type candidate for a given coding block with a palette coding candidate prior to rate distortion optimization evaluation in the video encoder. Performing such an override replacement before rate distortion optimization evaluation reduces the number of coding type candidates to be evaluated by the video encoder for a given coding block, thereby resulting in computational and memory resource savings. Example systems, apparatus, articles of manufacture, and methods disclosed herein are accordingly directed to one or more improvement(s) in the operation of a machine such as a computer or other electronic and/or mechanical device.

Further examples and combinations thereof include the following. Example 1 includes an apparatus comprising interface circuitry to access input video, computer readable instructions, and at least one processor circuit to be programmed by the computer readable instructions to map luminance components of pixels of a coding block of the input video to respective palette index values and respective residual values, encode the respective palette index values and the respective residual values to determine palette encoded luminance data for the coding block, and encode chrominance components of the pixels based on a coding type different from palette coding to determine encoded chrominance data for the coding block.

Example 2 includes the apparatus of example 1, wherein one or more of the at least one processor circuit is to quantize the luminance components of the pixels to determine respective identifiers for the pixels, populate a data structure based on the identifiers, prune the data structure to determine a color palette for the coding block, the color palette including a plurality of colors indexed by the palette index values, and map the luminance components of the pixels to the respective palette index values based on the color palette.

Example 3 includes the apparatus of example 1 or example 2, wherein the data structure includes a first number of entries corresponding to a first number of colors, and one or more of the at least one processor circuit is to select a subset of entries of the data structure to determine a second number of colors to include in the color palette, the second number of colors less than the first number of colors.

Example 4 includes the apparatus of any one of examples 1 to 3, wherein one or more of the at least one processor circuit is to select the subset of entries of the data structure based on a first threshold and a second threshold, the first threshold associated with prevalence of the identifiers in the data structure, the second threshold associated with uniqueness of the identifiers in the data structure.

Example 5 includes the apparatus of any one of examples 1 to 4, wherein one or more of the at least one processor circuit is to shift values of the pixels by a shift value to quantize the luminance components of the pixels, the shift value based on a quantization parameter and a bit size of the pixels.

Example 6 includes the apparatus of any one of examples 1 to 5, wherein the coding block is a first coding block, and one or more of the at least one processor circuit is to map the luminance components of pixels of the first coding block the respective palette index values and the respective residual values based on a first hash table, populate a second hash table corresponding to a second coding block based on pixels of the second coding block, and disable palette coding for the second coding block based on a determination that a size of the second hash table exceeds a valid hash table size.

Example 7 includes the apparatus of any one of examples 1 to 6, wherein one or more of the at least one processor circuit is to encode the chrominance components of the pixels based on intra coding to determine the encoded chrominance data for the coding block.

Example 8 includes an apparatus comprising interface circuitry to access palette index values corresponding respectively to pixels of a coding block of input video, the palette index values corresponding to a color palette associated with the coding block, computer readable instructions, and at least one processor circuit to be programmed by the computer readable instructions to estimate, based on the palette index values and a regression model, a number of bits to be used to palette encode the coding block, and select whether to palette encode the coding block based on the number of bits.

Example 9 includes the apparatus of example 8, wherein one or more of the at least one processor circuit is to determine the regression model based on configuration parameters including an offset value and a plurality of coefficient values.

Example 10 includes the apparatus of example 8 or example 9, wherein one or more of the at least one processor circuit is to compare ones of the palette index values for different neighbor pixels of the coding block to determine a first count value and a second count value, and evaluate the regression model based on the first count value, the second count value and the configuration parameters to estimate the number of bits.

Example 11 includes the apparatus of any one of examples 8 to 10, wherein one or more of the at least one processor circuit is to scan the pixels of the coding block in raster order, increment the first count value based on a first scanned pixel and a left neighbor pixel of the first scanned pixel having same palette index values, and increment the second count value based on (i) a second scanned pixel and a left neighbor pixel of the second scanned pixel having different palette index values and (ii) the second scanned pixel and an upper neighbor pixel of the second scanned pixel having same palette index values.

Example 12 includes the apparatus of any one of examples 8 to 11, wherein one or more of the at least one processor circuit is to determine the regression model further based on a width of the coding block and a height of the coding block, compare ones of the palette index values for different neighbor pixels of the coding block to determine a first count value and a second count value, and evaluate the regression model based on the first count value, the second count value, the configuration parameters, the width and the height to estimate the number of bits.

Example 13 includes the apparatus of any one of examples 8 to 12, wherein the interface circuitry is to accept color values of the color palette, and one or more of the at least one processor circuit is to estimate, based on the palette index values and the regression model, a first number of bits to encode the palette index values, estimate a second number of bits to encode the color values of the color palette, and estimate the number of bits to be used palette encode the coding block based on the first number of bits and the second number of bits.

Example 14 includes the apparatus of any one of examples 8 to 13, wherein one or more of the at least one processor circuit is to estimate a second number of bits based on a number of bits to encode a first color in the color palette and respective numbers of bits to encode differences between successive pairs of color in the color palette.

Example 15 includes an apparatus comprising interface circuitry to access a first plurality of coding candidates corresponding respectively to encoding a coding block of input video based on different coding types, computer readable instructions, and at least one processor circuit to be programmed by the computer readable instructions to replace, based on a condition, one of the first plurality of coding candidates with a palette coding candidate to determine a second plurality of coding candidates, the palette coding candidate corresponding to palette encoding of the coding block, and select one of the second plurality of coding candidates to be used to determine encoded data representative of the coding block.

Example 16 includes the apparatus of example 15, wherein the one of the first plurality of coding candidates is a first one of the first plurality of coding candidates, and one or more of the at least one processor circuit is to replace the first one of the first plurality of coding candidates with the palette coding candidate based on a first distortion value associated with the palette coding candidate being less than a second distortion value associated with a second one of the first plurality of coding candidates.

Example 17 includes the apparatus of example 15 or example 16, wherein the first one of the first plurality of coding candidates and the second one of the first plurality of coding candidates correspond to a same encoding type, and the second distortion value associated with the second one of the first plurality of coding candidates is lower than a third distortion value associated with the first one of the first plurality of coding candidates.

Example 18 includes the apparatus of any one of examples 15 to 17, wherein the first one of the first plurality of coding candidates and the second one of the first plurality of coding candidates correspond to intra coding.

Example 19 includes the apparatus of any one of examples 15 to 18, wherein one or more of the at least one processor circuit is to determine the first distortion value associated with the palette coding candidate based on a scale factor.

Example 20 includes the apparatus of any one of examples 15 to 19, wherein the palette coding candidate includes palette index values and residual values corresponding respectively to pixels of the coding block, and one or more of the at least one processor circuit is to determine the first distortion value based on the residual values and the scale factor.

Example 21 includes an apparatus comprising interface circuitry to access input video, computer readable instructions, and at least one processor circuit to be programmed by the computer readable instructions to cause the interface circuitry to transmit a coding block including palette encoded luminance data and encoded, and encoded chrominance data chrominance, the encoded chrominance data based on a coding type different from palette coding.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry to access input video;
computer readable instructions; and
at least one processor circuit to be programmed by the computer readable instructions to:
map luminance components of pixels of a coding block of the input video to respective palette index values and respective residual values;
encode the respective palette index values and the respective residual values to determine palette encoded luminance data for the coding block; and
encode chrominance components of the pixels based on a coding type different from palette coding to determine encoded chrominance data for the coding block.

2. The apparatus of claim 1, wherein one or more of the at least one processor circuit is to:
quantize the luminance components of the pixels to determine respective identifiers for the pixels;
populate a data structure based on the identifiers;
prune the data structure to determine a color palette for the coding block, the color palette including a plurality of colors indexed by the palette index values; and
map the luminance components of the pixels to the respective palette index values based on the color palette.

3. The apparatus of claim 2, wherein the data structure includes a first number of entries corresponding to a first number of colors, and one or more of the at least one processor circuit is to select a subset of entries of the data structure to determine a second number of colors to include in the color palette, the second number of colors less than the first number of colors.

4. The apparatus of claim 3, wherein one or more of the at least one processor circuit is to select the subset of entries of the data structure based on a first threshold and a second threshold, the first threshold associated with prevalence of the identifiers in the data structure, the second threshold associated with uniqueness of the identifiers in the data structure.

5. The apparatus of claim 2, wherein one or more of the at least one processor circuit is to shift values of the pixels by a shift value to quantize the luminance components of the pixels, the shift value based on a quantization parameter and a bit size of the pixels.

6. The apparatus of claim 1, wherein the coding block is a first coding block, and one or more of the at least one processor circuit is to:
map the luminance components of pixels of the first coding block the respective palette index values and the respective residual values based on a first hash table;
populate a second hash table corresponding to a second coding block based on pixels of the second coding block; and
disable palette coding for the second coding block based on a determination that a size of the second hash table exceeds a valid hash table size.

7. The apparatus of claim 1, wherein one or more of the at least one processor circuit is to encode the chrominance components of the pixels based on intra coding to determine the encoded chrominance data for the coding block.

8. An apparatus comprising:
interface circuitry to access palette index values corresponding respectively to pixels of a coding block of input video, the palette index values corresponding to a color palette associated with the coding block;
computer readable instructions; and
at least one processor circuit to be programmed by the computer readable instructions to:
estimate, based on the palette index values and a regression model, a number of bits to be used to palette encode the coding block; and
select whether to palette encode the coding block based on the number of bits.

9. The apparatus of claim 8, wherein one or more of the at least one processor circuit is to determine the regression model based on configuration parameters including an offset value and a plurality of coefficient values.

10. The apparatus of claim 9, wherein one or more of the at least one processor circuit is to:
compare ones of the palette index values for different neighbor pixels of the coding block to determine a first count value and a second count value; and
evaluate the regression model based on the first count value, the second count value and the configuration parameters to estimate the number of bits.

11. The apparatus of claim 10, wherein one or more of the at least one processor circuit is to:
scan the pixels of the coding block in raster order;
increment the first count value based on a first scanned pixel and a left neighbor pixel of the first scanned pixel having same palette index values; and
increment the second count value based on (i) a second scanned pixel and a left neighbor pixel of the second scanned pixel having different palette index values and (ii) the second scanned pixel and an upper neighbor pixel of the second scanned pixel having same palette index values.

12. The apparatus of claim 9, wherein one or more of the at least one processor circuit is to:
determine the regression model further based on a width of the coding block and a height of the coding block;
compare ones of the palette index values for different neighbor pixels of the coding block to determine a first count value and a second count value; and
evaluate the regression model based on the first count value, the second count value, the configuration parameters, the width and the height to estimate the number of bits.

13. The apparatus of claim 8, wherein the interface circuitry is to accept color values of the color palette, and one or more of the at least one processor circuit is to:
estimate, based on the palette index values and the regression model, a first number of bits to encode the palette index values;
estimate a second number of bits to encode the color values of the color palette; and
estimate the number of bits to be used palette encode the coding block based on the first number of bits and the second number of bits.

14. The apparatus of claim 13, wherein one or more of the at least one processor circuit is to estimate a second number of bits based on a number of bits to encode a first color in the color palette and respective numbers of bits to encode differences between successive pairs of color in the color palette.

15. An apparatus comprising:
interface circuitry to access a first plurality of coding candidates corresponding respectively to encoding a coding block of input video based on different coding types;
computer readable instructions; and
at least one processor circuit to be programmed by the computer readable instructions to:
replace, based on a condition, one of the first plurality of coding candidates with a palette coding candidate to determine a second plurality of coding candidates, the palette coding candidate corresponding to palette encoding of the coding block; and
select one of the second plurality of coding candidates to be used to determine encoded data representative of the coding block.

16. The apparatus of claim 15, wherein the one of the first plurality of coding candidates is a first one of the first plurality of coding candidates, and one or more of the at least one processor circuit is to replace the first one of the first plurality of coding candidates with the palette coding candidate based on a first distortion value associated with the palette coding candidate being less than a second distortion value associated with a second one of the first plurality of coding candidates.

17. The apparatus of claim 16, wherein the first one of the first plurality of coding candidates and the second one of the first plurality of coding candidates correspond to a same encoding type, and the second distortion value associated with the second one of the first plurality of coding candidates is lower than a third distortion value associated with the first one of the first plurality of coding candidates.

18. The apparatus of claim 17, wherein the first one of the first plurality of coding candidates and the second one of the first plurality of coding candidates correspond to intra coding.

19. The apparatus of claim 16, wherein one or more of the at least one processor circuit is to determine the first distortion value associated with the palette coding candidate based on a scale factor.

20. The apparatus of claim 19, wherein the palette coding candidate includes palette index values and residual values corresponding respectively to pixels of the coding block, and one or more of the at least one processor circuit is to determine the first distortion value based on the residual values and the scale factor.
